(19) United States
(12) Patent Application Publication
(10) Pub. No.: US 2018/0325305 A1
(43) Pub. Date: Nov. 15, 2018

(54) A DRINKS PREPARATION MACHINE FOR PREPARING A DRINK

(71) Applicant: QBO Coffee GmbH, Wallisellen (CH)

(72) Inventors: Ivo Aschwanden, Zürich (CH); Marius Hilckmann, Nottuln (DE); Robert Stein, Bad Bramstedt (DE)

(21) Appl. No.: 15/779,266

(22) PCT Filed: Nov. 28, 2016
(86) PCT No.: PCT/EP2016/079043

§ 371 Date: May 25, 2018

(30) Foreign Application Priority Data
Dec. 1, 2015 (EP) 15197380.7

(51) Int. Cl. A47J 31/44; A47J 31/40

(52) U.S. Cl. CPC A47J 31/4492; A47J 31/407

(57) ABSTRACT

A beverage-making machine for making a beverage from a portion capsule by introducing an extraction liquid into the portion capsule, having a housing, a capsule insertion opening, a closing unit, and a closing element. The housing has the capsule insertion opening, through which the portion capsule can be inserted into the capsule detection module, and the closing element is part of the closing unit. The closing element can be manually moved between an open position, in which the capsule insertion opening is accessible, and a closed position, in which the closing element closes the capsule insertion opening. The beverage-making machine has a capsule detection module which is designed to detect a capsule, which is introduced through the capsule insertion opening and which is located at a capsule detection position, using defined features. The beverage-making machine is designed to automatically trigger the capsule detection process after the closing element has assumed the closed position.

### BACKGROUND OF THE INVENTION

### Field of the Invention

The invention relates to the field of drinks preparation machines for preparing hot and/or cold drinks from an extraction material, for example coffee, which is contained in a portion capsule. In particular, the invention relates to a drinks preparation machine that includes a closure unit, a capsule recognition module, an operating element and a brewing module.

### Description of Related Art

Drinks preparation machines which use an extraction material which is brought into a portion capsule are known for example as coffee or espresso machines. It is likewise known to bring the portion capsule into the drinks preparation machine via a capsule insert opening. Such a capsule insert opening can be closable by way of a closure unit, which for its part includes a displaceable or pivotable element.

In particular, displaceable or pivotable elements of the mentioned type are used with drinks preparation machines with conventional, i.e. non-motorised, horizontal brewing modules. Herein, the slidable or pivotable element is mechanically coupled to the brewing chamber, so that the actuation of the mentioned element leads to the closing or opening of the brewing chamber.

EP 2 571 404 discloses a mechanical closure unit, concerning which the user closes the brewing chamber of the drinks preparation machine by way of moving a grip and simultaneously closes the capsule insert opening by way of the grip covering this opening. The brewing chamber is opened again and the capsule insert opening is rendered accessible again, by way of a corresponding opposite movement.

With regard to drinks preparation machines with motorised brewing modules, the closing of the capsule insert opening as a rule takes place via a covering, which can be operated, e.g., by way of pushing a button.

WO 2012/093107 discloses a drinks preparation machine, concerning which a motorised brewing module is combined with a manually operable covering and concerning which the closing of the covering is determined by a sensor and effects a closing travel of the brewing chamber. Herein, the covering is designed as a laterally guided plate, which is slidable along the housing of the drinks preparation machine and is arrested during the brewing procedure as well as during the opening and closing of the brewing chamber.

The application possibilities of these approaches are restricted to corresponding specific solutions. It would be desirable to provide approaches which improve the operating comfort as well as the safety.

### SUMMARY OF THE INVENTION

It is therefore an object of the invention to provide a drinks preparation machine which overcomes the disadvantages of the state of the art.

A further object is to provide a drinks preparation machine which further increases the user friendliness of drinks preparation machines for preparing a drink from a portion capsule. In particular, an object of the invention is to ensure that a user obtains a drink which he wishes, and only this drink, with a minimum of manipulation and with a high reproducibility.

A drinks preparation machine of the type according to the invention is designed as a drinks preparation machine for preparing a drink, in particular a hot drink such as coffee or tea, from a portion capsule. The drinks preparation machine includes a housing, a capsule insert opening, a closure unit with a closure element and a capsule recognition module.

The capsule insert opening is designed as an opening in the housing, through which opening the portion capsule can be inserted into the capsule recognition module.

The closure element is a manually movable part of the closure unit, which is movable between an open and a closed position.

In the closed position, the closure element closes the capsule insert opening. In particular, the closure element is designed such that in the closed position, no object gets into the inside of the drinks preparation machine and/or that no light gets into the inside of the drinks preparation machine. For this reason, at least the part of the closure element can be manufactured of a non-transparent material. This is particularly advantageous with a capsule recognition that is based on optical features.

The capsule insert opening is accessible in the open position. In particular, the closure element leaves the capsule insert opening uncovered to such an extent that the portion capsule can be inserted through the capsule insert opening.

The capsule recognition module is configured to carry out a capsule recognition on a portion capsule that was brought through the capsule insert opening into a capsule recognition position. The capsule recognition is effected by way of predefined features.

With the drinks recognition module, in particular one can firstly determine whether the inserted capsule is suitable for use in the drinks preparation machine in the first place, or not—and this is known per se. Secondly, there exists the possibility of outputting corresponding information to the user, for example via a display, on the basis of the recognised capsule characteristics. For example, the drink type (coffee, tea, etc.), the sort (e.g. “100% Arabica”), the recommended preparation manner (e.g. “espresso”, “ristretto” or “lungo” etc.) and/or other information can be displayed. Thirdly, the program that is implemented by the coffee machine for the brewing can be selected on the basis of the recognised capsule sort; for example the brewing pressure, the brewing duration as well as possibly also the temperature and/or other characteristics can be set depending on whether the inserted capsule is envisaged for the preparation of, e.g., ristretto, espresso or lungo.

In particular, the predefined features are optically readable features. The capsule recognition module then includes an optical sensor, for example a camera, for reading out the predefined features. However, other features, such as, for example, magnetic characteristics or an RFID-chip that can be read out in a contact-free manner are also conceivable.

According to the invention, the drinks preparation machine is now configured such that the capsule recognition takes place automatically after the assumption of the closed position by the closure element. In comparison to procedures which are activated by the user, this procedure on the one hand has the advantage that in the case of capsule recognition modules with an optical sensor, one prevents scatter light from getting through the capsule insert opening into the capsule recognition module—the capsule recognition is coupled to a closure and therefore also to the darkening of the capsule recognition module. The capsule recognition module can include its own light source for the reading-out, the light source producing a defined light distribution on the portion capsule. A further advantage results from the intuitive operation: the user does not necessarily notice at all that he activates a capsule recognition procedure.

The portion capsule is located in the capsule recognition position during the capsule recognition, wherein in an embodiment, the portion capsule and the components for reading out predefined features do not carry out a relative movement to one another. In other words: the portion capsule and the components that are essential for reading out the predefined features, for example the optical sensor and/or the light source do not move relative to one another during the capsule recognition.

In particular, the predefined features include a coding that contains details concerning one or more capsule characteristics. Examples of such capsule characteristics have already been mentioned. In particular, these are details on the applicability of a use of the portion capsule in the drinks preparation machine and details related to the capsule, details, such as, for example, drinks type, variety and/or recommend preparation type.

Suitable, optically readable features for example are a bar code, a 2D matrix code (for example QR code or Aztec code), a pictogram (icon) and/or a certain colouring. A code according to the European patent applications no. 14 197 487.3, 14 197 488.1 and/or no. 14 197 489.9 are also considered.

In an embodiment of the drinks preparation machine, this includes a sensor, with which the assumption of the closed position by the closure element or the transition of this into the closed position can be determined. The determining of the closed position or of the transition into the closed position in particular serves for activating the capsule recognition.

In particular, the capsule recognition is activated (triggered) after the assumption of the closed position which is specified by the mentioned sensor.

The sensor can be designed for example as a switch which, given the assumption of the closed position by the closure element, interacts with a region of the closure unit. In particular, this region of the closure element moves in a reproducible manner in dependence on the movement of the closure element.

In an embodiment, the drinks preparation machine includes a display device, for example a display and/or buttons with an individually changeable colour impression, and an operating element, for example, a jog dial and/or a screen. The display device and the operating element can also be realised by an element, for example a touch screen or the buttons with an individually changeable colour impression.

The drinks preparation machine can be configured, via the display device, to display a number of brewing programs that can be selected via the operating element. Herein, the number of selectable brewing programs can be dependent on a result of the capsule recognition.

At least the selectable brewing programs can thereby be restricted to those brewing programs that can be prepared by the drinks preparation machine at the point in time of the selection. As to which brewing programs can be prepared at the momentary point in time and therefore selected depends on the condition of the drinks preparation machine and its modules, in particular on filling levels and/or the result of the capsule recognition.

In an embodiment, the drinks preparation machine further includes a milk module, wherein the condition of the milk module can likewise influence the number of selectable brewing programs. The condition of the milk module in particular is defined by its connection or its non-connection to the drinks preparation machine as well as possibly by a filling level.

In an embodiment of the drinks preparation machine, the closure element is also movable out of the closed position during a brewing process, which serves for preparing the drink, i.e., the closure element is not arrested during the brewing process. Herein, a movement of the closure element during the brewing process leads, for example, to the stopping of the brewing process—in this embodiment therefore a very intuitive possibility of stopping the brewing process is available to the user.

By way of a suitable programming of the drinks preparation machine, one can determine whether the moving of the closure element during the brewing process only interrupts this, i.e. whether it is continued after a renewed assumption of the closed position by the closure element or whether the brewing process is valid as being completed.

The drinks preparation machine can include a brewing module in the manner known per se. This includes a first brewing module part and a second brewing module part that is movable relative to the first brewing module part. For this, the first and second brewing module part are designed to form a brewing chamber, which, during the brewing procedure at least partly surrounds the portion capsule, which is located in the brewing position. The brewing module is configured, by way of intruding an extraction fluid into the portion capsule, to brew a brewed drink and to discharge this out of the brewing module. The movement of the second brewing module part can be mechanically decoupled from the movement of the closure element. This means that a movement of the closure element does not lead to a direct movement of the second brewing module part any more than a movement of the second brewing module part leads to a movement of the closure element. Such a mechanical decoupling of the closure element and the second brewing module part also permits a brewing process, which is stopped via the moving of the closure element out of the closed position, to be continued after the closure element has been brought again into the closed position.

The mentioned mechanical decoupling, alternatively to the approach mentioned above, of interrupting the brewing process by way of opening the closure unit, also permits the closure element to be brought into the open position without interrupting the running brewing process. It is particularly with embodiments, concerning which the portion capsule is not brought directly into a position between the first and second brewing module part via the capsule insert opening and the capsule recognition position is different from the brewing position, that this can be advantageous and, for example, lead to a quicker sequence of drinks preparations that are subsequent to one another.

Furthermore, the assumption of the closed position by the closure element can be a requirement for the movement of the second brewing module part. By way of this, the safety of the user is also ensured in the case that the closure element is moved out of its closed position during the closing or opening of the brewing chamber.

The capsule recognition position and the brewing position can be different from one another. After an effected capsule recognition, a transfer of the portion capsule from the capsule recognition position into the brewing position is necessary. In particular, one can envisage the mentioned transfer requiring an activation by the user, for example by way of the selection of a brewing program which can be selected after the capsule recognition.

Alternatively, such a transfer can also be activated in one of the following manners:
The user has selected a selectable recipe before the capsule recognition and the capsule recognition has resulted in a portion capsule that matches the selection;
The user has given his consent to an automated start of the brewing procedure without a capsule recognition or without taking the capsule recognition into account, before the insertion of the portion capsule into the capsule insert opening or before the capsule recognition;
The user has given his consent to a start of the brewing procedure without taking into account the capsule recognition, after the capsule recognition,

Supplementarily, a completion of a rinsing, which precedes the drinks preparation, can be a requirement for the mentioned transfer.

In an embodiment, the portion capsule is removable again out of the drinks preparation machine via the capsule insert opening after the capsule recognition, but before the closing of the brewing chamber. Since the portion capsule remains unscathed until the closing of the brewing chamber, the intact portion capsule can consequently be removed again from the drinks preparation machine for a later use. If, as mentioned, the capsule recognition position is different from the brewing position, then such a removal can be possible before the transfer into the brewing chamber—for example if the user, via the display device, recognises that the capsule sort is not suitable for preparing the drinks that he desires.

In particular, the drinks preparation machine can include a grip recess that is accessible from the capsule insert opening. This permits the user to grip the portion capsule that is located in the capsule recognition position and to remove it via the capsule insert opening.

The possibility of a removal of the portion capsule after the capsule recognition can be made dependent on presettings and, for example, can be set to unlimited, temporally limited or not possible at all.

An essential advantage of the drinks preparation machine according to the invention is the fact that this permits a selection of a certain preparation process with adapted parameters such as pressure, temperature, water quantity, possible milk quantity etc., after inserting the portion capsule. If the capsule recognition position is different from the brewing position, then a rinsing of the brewing chamber can also be activated after the insertion of the portion capsule, for example depending on the desired drink and/or depending on prior history.

In particular, the preparation process can be selected in dependence on the results of the capsule recognition.

In an embodiment, the closure element is an operating lever, which is pivotable about a rotation axis.

In particular, the operating lever is designed such that on the one hand, in the closed position, it closes the capsule insert opening and on the other hand can be easily gripped and guided in each position.

The closure element can alternatively be a slide, which is guided along the housing and is movable from a first position, in which the slide does not close the capsule insert opening, into a second position, in which the slide comes to lie over the capsule insert opening.

In embodiments, in which the closure element is an operating lever, the closure unit can moreover include a cam, which is likewise movable about the rotation axis and which, at least in the closed position of the closure unit, interacts with the sensor in a manner such that the transition into the closed position and/or the condition of the closed position can be determined via the sensor or via an output signal of the sensor.

The cam and the operating lever can be manufactured of one piece. In this case, the cam and the operating lever form a rocker, which in the closed position interacts with the sensor.

The cam and operating lever can be two different parts of the closure unit, wherein the movement of the cam is in an unambiguous and repeatable relation with the movement of operating lever.

The closure element can be movable into the closed position and movable away out of this by way of applying a force. In particular, the closure unit can be configured such that the closure element is continuously movable. The continuous movement can be interrupted or completed by a possibly sudden latching-in at characteristics positions, in particular in the closed position and in the open position.

In an embodiment, the closure unit further includes a resistance element, in order to provide the user who applies the force for moving the closure element, with a haptic feedback, i.e. the resistance element is designed such that it forms a resistance to a movement of the closure element, the resistance being dependent on a position of the closure element, by which means the force, which is necessary for moving the closure element, is also dependent on a position of the closure element.

If, for example, the closure unit is realised as an operating lever, which is pivotable about a rotation axis, then the position of the operating lever can be given by its angular position, which is given via its movement about the rotation axis relative to the closed position. In this case, the resistance varies in dependence on the angular position.

In particular, the resistance is designed such that the haptic feedback simulates procedures, which are characteristic of drinks preparation machines with a manually closable brewing chamber. For example, the piercing of the portion capsule and/or the closing of the brewing chamber belongs to these procedures.

In an embodiment, the resistance is created by friction and/or elastic deformation. For this, the resistance element can be a spring, which, on closing, is deformed against its spring force and/or along which an element of the closure unit drags. In an embodiment example, the resistance element is a curved sheet spring, along which a part of the closure unit travels.

Alternatively or supplementarily, embodiments that include a first brewing module part and a second brewing module part, which is movable relative to the first brewing module part, can be configured to eject a spent portion capsule out of the brewing module without actuating the closure element, i.e. the drinks preparation machine is programmed to open the brewing chamber after completion of the brewing process, until the spent portion capsule drops downwards into the capsule container, even if the user has neither actuated the closure element nor made a dedicated input.

### BRIEF DESCRIPTION OF THE DRAWINGS

Embodiment examples of the invention are hereinafter described by way of figures. In the figures, the same reference numerals indicate the same or analogous elements. There are shown in:

FIG. 1 a view of a drinks preparation machine that, amongst other things, includes a capsule recognition module, a closure element, a milk module, a display device and an operating element;

FIG. 2 a cross section of a region of a drinks preparation machine with an installed closure unit, whose closure element is in an open position and with a sensor for determining the assumption of a closed position by the closure element;

FIG. 3 a cross section of the region of the drinks preparation machine according to FIG. 2 with the closure element in the closed position;

FIG. 4 a detailed view of an embodiment of a resistance element for producing a haptic feedback.

### DETAILED DESCRIPTION OF THE INVENTION

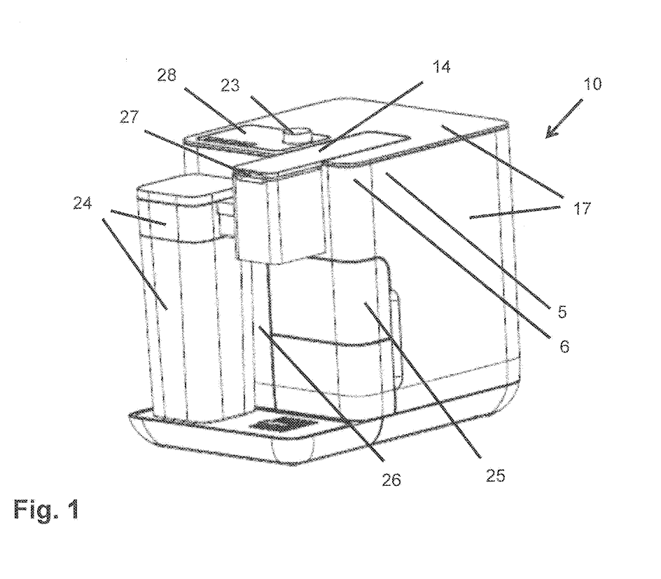

FIG. 1 shows an outer view of a drinks preparation machine 10 for preparing a drink from a portion capsule which apart from a closure element, which is realised by an operating lever 14 and is in the closed position, includes a capsule recognition module 5, a housing 17 including a capsule insert opening 11, a brewing module 6, an operating element 23, a display device 28, a milk module 24, a capture container 25 and a water tank 26 (partly covered by the milk module 24).

The operating lever 14 is designed to form a horizontal surface with the upper, horizontal part of the housing 17 in the closed position and to completely cover the capsule insert opening 11 as well as the upper region of the capsule recognition module 5, in the closed position (reference numeral represents the rough position in the inside of the drinks preparation machine 10). The operating lever 14 and regions of the housing 17, which are adjacent to it, include recesses 27 for an improved manual operability of the operating lever 14.

The brewing module 6 (reference numeral represents the approximate position in the inside of the drinks preparation machine 10) is arranged directly below the capsule recognition module 5.

The milk module 24, the water tank 26 and the capture container 25 are examples of modules of the drinks preparation machine 10 that on account of their filling level and/or their presence or their absence influence the brewing programs, which can be selected by the user, for drinks that can be prepared by the drinks preparation machine 10 in its present condition.

The selectable brewing programs are visible on the display device 28, which is a display and can be selected via the operating element 23, which here is a jog dial. An operation via a touchscreen operating element that unifies the display device 28 and the operating element 23, or remotely via a mobile device which communicates with the drinks preparation machine 10 is also conceivable, wherein the communication in particular takes place in a wireless manner.

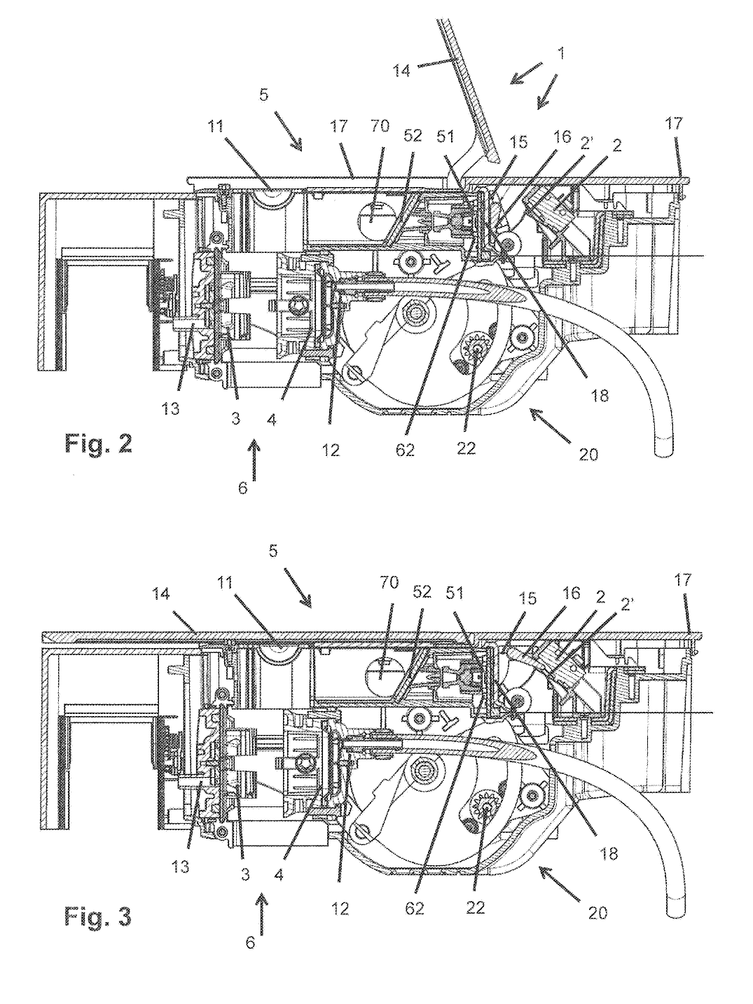

FIG. 2 shows the part-region of a drinks preparation machine 10 for preparing a drink from a portion capsule, the part-region being relevant to the invention. What is represented, amongst other things, are the functional units—the capsule recognition module 5, the closure unit 1, the brewing module 6 and the drive mechanism 20.

In the shown embodiment, the capsule recognition module 5 is arranged directly below the upper, horizontal part of the housing 17 in a manner such that a portion capsule can be inserted via the capsule insert opening 11 into a capsule recognition position of the capsule recognition module 5.

The brewing module 6 lies below the capsule recognition module 5. In the shown embodiment, the brewing module 6 includes a first brewing module part 3, which is fixedly connected to the housing 17, and a second brewing module part 4, which is movable relative to the first brewing module part 3. The position of the brewing module 6 is selected such that a portion capsule, which is located in the capsule recognition position, is held in the capsule recognition position by the second brewing module part 4 and that the portion capsule, which is located in the capsule recognition position, can get into a brewing position between the two brewing module parts inasmuch as the second brewing module part 4 assumes a position that no longer prevents this transfer of the portion capsule from the capsule recognition module 5 into the brewing module 6.

FIG. 2 yet shows two further components of the brewing module 6, specifically the injector 12 and the discharge device 13, for a better orientation.

The drive mechanism 20 connects onto the brewing module 5 towards the rear side of the housing 17 in the shown embodiment of the drinks preparation machine 10. The drive mechanism 20 is driven by an electric drive 22 (a motor). A description of the drive mechanism 20 and in particular a representation of a possible principle, with which the transfer from the capsule recognition position into the brewing position is regulated is to be found, for example, in the European patent application no. 14 195 680.5.

The parts of the closure unit 1, which are within the housing, in the shown embodiment of the drinks preparation machine 10 are arranged at the rear of the capsule recognition module 5. In particular, the parts of the closure unit 1, which are inside the housing, are arranged at the rear of a circuit board 18, which delimits the capsule recognition module 5 and which includes the sensor electronics of the capsule recognition module 5.

The shown closure unit 1 includes a cam 16 as well as the operating lever 14, which are connected to one another in a rotationally fixed manner and are pivotable together about a rotation axis 15.

In the shown embodiment, the operating lever 14 is movable about the rotation axis 15 and is designed, such that it can assume a position, in which it can form a horizontal surface with the upper, horizontal part of the housing 17, as is shown in FIG. 1, and thereby completely covers the capsule insert opening. The darkening within the capsule recognition module 5, which is necessary for the capsule recognition on the basis of determining optically readable features, is achieved by way of this. Furthermore, the operating lever 14 is designed to be easily gripped and operated in each position.

The drinks preparation machine 10 further includes a microswitch 2 with a sheet metal tab 2′, in order to determine the assumption of the closed position by the operating lever 14 and to automatically activate the capsule recognition. The microswitch 2 and the sheet metal tab 2′ are arranged in the housing 17 such that the cam 16 presses against the sheet metal tab 2′ in the closed position of the operating lever 14, by which means the microswitch 2 detects the assumption of the closed position, which can be read out by a machine control.

The shown capsule recognition module 5 includes a camera sensor 51, a capsule recognition window 52, a light source 62 and a fan 70. Capsule recognition modules for drinks preparation machines for preparing a drink from a portion capsule are described in the European patent application no. 14 195 680.5.

FIG. 3 shows the region of the drinks preparation machine 10, which is represented in FIG. 2, with the closure element 14, which is realised as an operating lever 14, in the closed position. From this, it is evident as to how the operating lever 14 engages into a recess of the housing 17 and thereby closes the capsule insert opening 11.

FIG. 3 moreover shows how the cam 16 presses against the sheet metal tab 2′ of the microswitch 2 in the closed position of the operating lever 14, by which means one can determine whether the closed position is assumed or that a transition into the closed position takes place. The latter automatically activates the capsule recognition by the capsule recognition module 5. The position of the sheet metal tab 2′ in FIG. 3 is represented to the left of the cam 16 instead of between the cam 16 and the sensor 2, which is not completely correct.

The closure unit 1, which is installed into the shown drinks preparation machine 10, further includes a resistance element for creating a haptic feedback. The object of the resistance element is to produce a resistance against the movement of the operating lever 14, the resistance varying in dependence on the position of the operating lever 14.

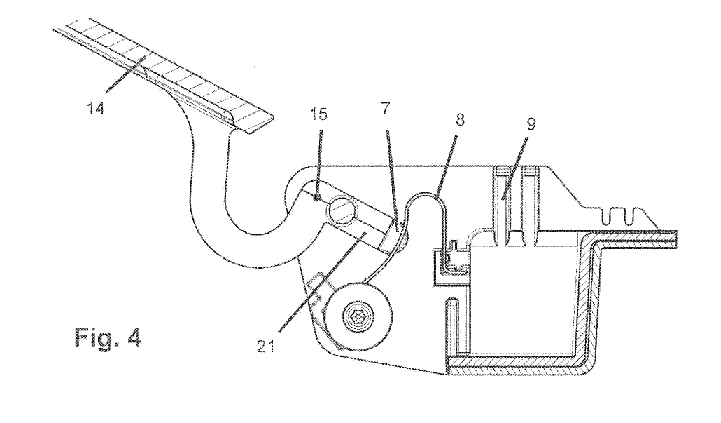

A specific realisation of such a resistance element is shown in FIG. 4. The resistance element includes a bent sheet spring 8 and a resistance holder 9. The operating lever 14 moreover includes two fork-like resistance continuations 21 close to the rotation axis 15 (only the rear one of the two resistance continuations 21 is shown). Plastic caps 7, which press against the bent sheet spring 8, are attached at the end of these two resistance continuations 21.

On moving the operating lever 14, friction and therefore a resistance, which can be perceived by the user, arises on account of the pressure between plastic caps 7 and the sheet spring 8, and the sheet spring is moreover deformed against its spring force to a particularly large extent by the resistance continuations 21 when the operating lever 14 approaches the closed position. As soon as the spring arch has been overcome, the user feels a sudden compliance, similar to a latching. The pressing pressure and therefore the magnitude of the friction or the resistance can be set via the contour of the sheet spring 8, which is to say via its local bending. The resistance can herewith be varied in an arbitrary manner over the movement region of the operating lever 14. In particular, a varying resistance that imitates the mechanical resistance of a brewing group can be imitated.

### LIST OF REFERENCE NUMERALS

1 closure unit
2 sensor/microswitch
2′ sheet metal tab
3 first brewing module art
4 second brewing module part
5 capsule recognition module
6 brewing module
7 plastic cap
8 sheet spring
9 resistance holder
10 drinks preparation machine
11 capsule insert opening
12 injector (water feed)
13 discharge device (drinks outlet)
14 operating lever
15 rotation axis
16 cam
17 housing
18 circuit board (PCB)
20 drive mechanism
21 resistance continuation
22 electric drive
23 operating element
24 milk module
25 capture container
26 water tank
27 recesses
28 display device
51 camera sensor
52 capsule recognition window
62 light source
70 fan

1. A drinks preparation machine for preparing a drink from a portion capsule by way of introducing an extraction fluid into the portion capsule, comprising:
a housing that comprises a capsule insert opening, through which the portion capsule can be inserted into the drinks preparation machine;
a closure unit with a closure element that is movable manually between an open position, in which the capsule insert opening is accessible, and a closed position, in which the closure element closes the capsule insert opening,
wherein a capsule recognition module, which is configured to carry out a capsule recognition on a portion capsule that is inserted through the capsule insert opening and is located at a capsule recognition position, on the basis of predefined features, wherein the drinks preparation machine is configured to automatically activate the capsule recognition after assumption of the closed position by the closure element.

2. The drinks preparation machine according to claim 1, comprising a sensor that is configured to determine the assumption of the closed position by the closure element.

3. The drinks preparation machine according to claim 1, further comprising a display device and an operating element, wherein the drinks preparation machine is configured, via the display device, to display a number of brewing programs which can be selected via the operating element, in a manner depending on the result of the capsule recognition.

4. The drinks preparation machine according to claim 3, further comprising a milk module, wherein the drinks preparation machine is configured to adapt the selectable brewing programs to the presence or absence of the milk module and/or to a milk module filling level.

5. The drinks preparation machine according to claim 1, wherein the closure element is movable out of the closed position during a brewing process which serves for preparing the drink, wherein this movement of the closure element stops the brewing procedure.

6. The drinks preparation machine according to claim 1, comprising a brewing module with a first brewing module part and a second brewing module part which is movable relative to the first brewing module part, wherein a brewing chamber can be formed by the first and the second brewing module part, and wherein the movement of the second brewing module part relative to the first brewing module part and the movement of the closure element are mechanically decoupled from one another.

7. The drinks preparation machine according to claim 6, which is configured, after the capsule recognition has been effected, to permit a removal of the portion capsule through the capsule insert opening before the brewing chamber is closed.

8. The drinks preparation machine according to claim 7, further comprising a grip recess which is accessible from the capsule insert opening, for removing the portion capsule which is located at the capsule recognition position.

9. The drinks preparation machine according to claim 6, wherein the capsule recognition position and a brewing position, in which the portion capsule is located given a closed brewing chamber, are different from one another and wherein a transfer of the portion capsule from the capsule recognition position into the brewing position requires an activation by the user.

10. The drinks preparation machine according to claim 1, wherein the predefined features, by way of which the capsule recognition is carried out, comprises a coding which contains details on one or more capsule characteristics.

11. The drinks preparation machine according to claim 1, wherein the predefined features, by way of which the capsule recognition is carried out, are optically readable features and the capsule recognition module comprises an optical sensor for reading out the predefined features.

12. The drinks preparation machine according to claim 1, wherein the closure element is an operating lever which is pivotable about a rotation axis.

13. The drinks preparation machine according to claim 1, wherein the closure element is movable by way of applying a force and wherein the closure element further comprises a resistance element (8) which opposes a movement of the closure element with a resistance which is dependent on a position of the closure element.

14. The drinks preparation machine according to claim 13, wherein the resistance is based on friction and/or an elastic deformation.

15. The drinks preparation machine according to claim 1, wherein the brewing module comprises a first brewing module part and a second brewing module part which is movable relative to this, wherein a brewing chamber can be formed by the first and the second brewing module part, and wherein the drinks preparation machine is further configured to eject a spent portion capsule out of the brewing module without actuating the closure element.
